(19) United States
(12) Patent Application Publication
(10) Pub. No.: US 2015/0071289 A1
(43) Pub. Date: Mar. 12, 2015

(54) SYSTEM AND METHOD FOR ADDRESS RESOLUTION

(71) Applicant: ELECTRONICS AND TELECOMMUNICATIONS RESEARCH INSTITUTE, Daejeon (KR)

(72) Inventors: Ji Soo SHIN, Daejeon (KR); Saehoon KANG, Daejeon (KR); Sunhee YANG, Daejeon (KR)

(21) Appl. No.: 14/476,943

(22) Filed: Sep. 4, 2014

(30) Foreign Application Priority Data
Sep. 11, 2013 (KR) 10-2013-0109342

(51) Int. Cl. H04L 12/741; H04L 12/947

(52) U.S. Cl. CPC H04L 45/745; H04L 49/25
USPC 370/392

(57) ABSTRACT

In an address resolution system in a centralized network control environment including a plurality of software defined network (SDN) switches, an address resolution protocol (ARP) controller checks whether an ARP table has a MAC address corresponding to the destination IP address of an ARP request packet when the ARP request packet is received from a source host. An SDN controller determines whether to broadcast the ARP request packet according to the existence of the MAC address corresponding to the destination IP address in the ARP table.

### CROSS-REFERENCE TO RELATED APPLICATION

This application claims priority to and the benefit of Korean Patent Application No. 10-2013-0109342 filed in the Korean Intellectual Property Office on Sep. 11, 2013, the entire contents of which are incorporated herein by reference.

### BACKGROUND OF THE INVENTION

1. Field of the Invention

The present invention relates to a system and method for an address resolution, and more particularly, to a system and method that matches an IP address with a MAC address in a centralized control network environment.

2. Description of the Related Art

A software defined network (SDN) separates a control plane and a data plane in network equipment, such as a switch or a router. And SDN technology programs the packet processing by the operation of a network in software, not a protocol of the network equipment.

In the SDN, a centralized controller controls the path of packets at the outside of the equipment, independently from an equipment vendor. The SDN changes a closed network technology into an open networking technology through open interfaces of the controller. And the SDN has been in the spotlight as a future Internet technology which can reduce CAPEX (capital expenditures) and OPEX (operating expenses) of a network.

The SDN controller has centralized control network functions such as the topology management and state management, and controls forwarding and routing based on a global view of the network state. The SDN controller can control and manage the network very flexibly in software, because it determines differentiated forwarding and packet processing rules in response to application policies of the upper layer, and transfers the rules to a data plane performing switching and routing.

An address resolution protocol (ARP) is used for resolution of network address into a physical layer address. The physical layer address means the layer-2 address, such as the Ethernet MAC address in an IP network or the ATM address in an asynchronous transfer mode (ATM) network. To communicate between two hosts in Ethernet, the source host needs to know the MAC address of destination host. For example, when a host A attempts to send a packet to a host B, the host A needs to know the MAC address of the host B. If the host A does not have the MAC address of the host B, the host A broadcasts an ARP request packet to the entire network to get the MAC address of the host B. The host B that has received the ARP request packet transmits an ARP reply packet to the host A to inform the MAC address of the host B.

A gratuitous ARP (GARP) is used to update mapping information of other hosts in a network when the host information is changed. The GARP protocol is not an indispensable protocol, but supported in many operating systems as default.

When the IP address of the host A has been changed, the host A tries to check whether the same IP address is being used in the network by broadcasting a GARP request packet including its own IP and MAC address. After receiving the GARP request packet, the host B may transmit a GARP reply packet if it uses the same IP address of the host A. If the host A receives the GARP response packet, it means that there is a host which uses the same IP address. Therefore the host A changes its IP address in order to prevent an IP address collision.

Furthermore, the host A broadcasts a GARP request packet again in order to correct the ARP tables of the other hosts that have received the first GARP request packet.

If the host A does not receive the GARP reply packet, the host A may use this IP address because there is no host that has the same IP address in the network.

There is another way to notify the change of the IP address. If the IP address of the host A changed, the host A broadcasts an ARP reply packet. In this ARP reply packet, the host A fills the source and destination IP address fields and the source and destination MAC address fields with those of the host A.

As another method, the IP address of the host A has been changed, the host A broadcasts an ARP reply packet to inform a change of the IP address. In this case, the host A sets the source/destination IP fields and the source/destination MAC fields of the ARP reply packet as IP address of the host A.

The pairs of the IP and MAC address collected as described above are stored in the ARP table of each host, and used for next packet transmission. An entry of the ARP table has an age to automatically expire the unused entry from the ARP table.

As described above, broadcasted packets can be overhead of a network. Although the number of broadcasted packets can be reduced by properly optimizing the age value of the ARP table entry, the fundamental problem remain unsolved.

The overhead of broadcast packets can be applied to the SDN environment in the same way. And this problem can influence in a large-size network or a virtualization environment. That is, the number of broadcasted packets can be exponentially increased in a virtualization environment in which hosts are frequently generated and deleted, or host information is frequently changed.

### SUMMARY OF THE INVENTION

The present invention tries to provide a system and method for the address resolution, which can reduce the number of broadcasting packets in a centralized control network environment.

According to an embodiment of the present invention, an address resolution system is proposed in a network including a plurality of SDN switches. The address resolution system includes an address resolution protocol (ARP) table, an ARP controller, and an SDN controller. The ARP table stores pairs of a MAC and IP address. The ARP controller checks whether the ARP table has the MAC address corresponding to the destination IP address of ARP request packet sent from a source host through a first SDN switch.

If the corresponding MAC address is in the ARP table, the SDN controller commands the first SDN switch to send the ARP reply packet including the corresponding MAC address to the source host.

On the other hand, if there is no corresponding MAC address in the ARP table, the SDN controller commands all SDN switches to broadcast the ARP request packet.

When the SDN controller receives ARP reply from the destination host that uses the destination IP address of the ARP request packet, it calculates a forwarding path and makes forwarding rules to deliver ARP reply packet. And it commands all SDN switches among the forwarding path to forward ARP reply packet to the source host.

During above step, the ARP controller can update the ARP table using the destination IP and MAC address pair.

If the SDN controller receives the GARP reply packet from a second SDN switch of the destination host, it may determine whether it broadcasts the GARP reply packet or not according to the existence of the IP and MAC address pair in the ARP table.

The SDN controller checks an IP collision when the source MAC address is in the ARP table and the source IP address does not exist in the ARP table. If there is no collision of IP addresses, the SDN controller creates rules so that the GARP reply packet is forwarded to hosts that have changed MAC information instead of broadcasting the GARP request packet.

The SDN controller sends an Internet control message (ICMP) echo request packet with the source MAC and IP address according to the decision of the ARP controller. The ARP controller can determine an IP collision when it receives an ICMP echo reply packet corresponding to the ICMP echo request packet.

The SDN controller creates rules to the SDN switches so that the GARP request packet is broadcasted to the network if it receives an error packet corresponding to the ICMP echo request packet.

The SDN controller creates rules to the SDN switches so that the GARP request packet is broadcasted to the network if the source IP and MAC address pair exists in the ARP table.

The ARP controller may set the age field for the entry if the source IP and MAC address pair exists in the ARP table.

The ARP controller can save the source MAC address corresponding to the source IP address to the ARP table if the source MAC address does not exist in the ARP table.

In accordance with another exemplary embodiment of the present invention, a method for resolving, by an address resolution system, a MAC address corresponding to an IP address in a centralized control network environment that includes several SDN switches is provided. The address resolution method includes followings.
The step of receiving, by the SDN controller, an ARP request packet from the source host in the SDN controller
The step of checking, by the ARP controller, whether the MAC address corresponding to the destination IP address of the ARP request packet exists in the ARP table
The step of determining, by the SDN controller, whether broadcast the ARP request packet according to the existence of the MAC address corresponding to the destination IP address

The step of determining of the address resolution method above can include the step of broadcasting the ARP request packet to the network if the MAC address corresponding to the destination IP address of the ARP request packet, and the step of forwarding the ARP reply packet with the MAC address to the source host if the MAC address corresponding to the destination IP address of the ARP request packet.

The address resolution method may further include the step of receiving, by the SDN controller, an ARP reply packet with the MAC address of a host that uses the same IP address among hosts that have received the broadcasted ARP request packet, and the step of forwarding, by the SDN controller, the ARP reply packet to the source host.

The address resolution method may further include the step of receiving, by the SDN controller, the GARP request packet from the host that have changed the MAC information, and the step of checking, by the ARP controller, the existence of the source IP and MAC address pair of the GARP request packet in the ARP table, and the step of broadcasting, by the SDN controller, the GARP request packet according to the existence of the source IP and MAC address pair.

The step of broadcasting of the GARP request packet may include the step of broadcasting the GARP request packet to the network if the source MAC address does not exist in the ARP table.

The step of broadcasting of the GARP request packet may further include the step of checking an IP collision if the ARP table does not have the source IP address but has the source MAC address, and the step of forwarding the GARP reply packet to hosts that have changed information if there is an IP collision.

The step of determining whether broadcasts the GARP request packet may further include the step of broadcasting the GARP request packet to the network if the source MAC address and IP address pair is in the ARP table.

### BRIEF DESCRIPTION OF THE DRAWINGS

FIG. 1 is a diagram showing an example of a centralized network control environment that is applied to an exemplary embodiment of the present invention.

FIGS. 2 and 3 are diagrams showing an example of an address resolution system in accordance with exemplary embodiments of the present invention.

FIG. 4 is a flowchart showing a procedure of processing an ARP request packet in the address resolution system in accordance with an exemplary embodiment of the present invention.

FIG. 5 is a flowchart showing a procedure of processing an ARP reply packet in the address resolution system in accordance with an exemplary embodiment of the present invention.

FIG. 6 is a flowchart showing a procedure of processing a GARP request packet in the address resolution system in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification and claims. In addition, unless explicitly described to the contrary, the word “comprise” and variations such as “comprises” or “comprising” will be understood to imply the inclusion of stated elements but not the exclusion of any other elements.

A system and method for an address resolutionre in accordance with some exemplary embodiments of the present invention are described in detail below with reference to the accompanying drawings.

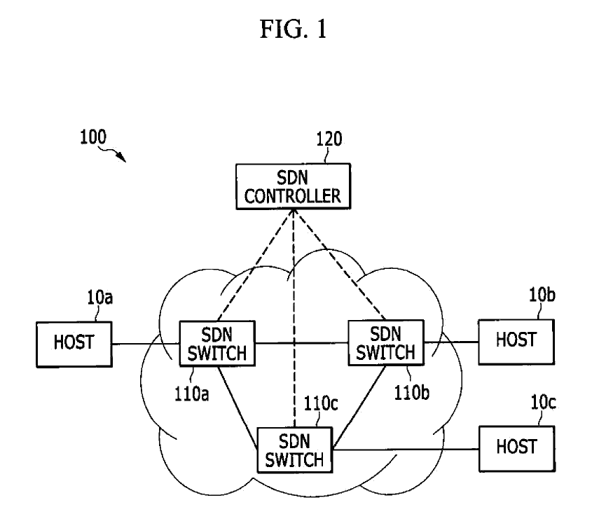

FIG. 1 is a diagram showing an example of a centralized control network environment that is applied to an exemplary embodiment of the present invention.

As described in FIG. 1, the centralized control network environment, for example, a software defined network (SDN) 100, includes a plurality of SDN switches, for example, SDN switches 110a, 110b, and 110c, and an SDN controller 120.

The SDN switches 110a, 110b, and 110c may be connected with hosts 10a, 10b, and 10c, and are controlled by SDN controller 120. All packets are forwarded, flooded, or dropped based on the forwarding rules, received from the SDN controller 120, in SDN switches.

The hosts 10a, 10b, and 10c may be user equipments such as a laptop, a smart phone, a desktop, and so on.

The SDN controller 120 controls the SDN switches 110a, 110b, and 110c. In detail, the SDN controller 120 controls all packet forwarding based on a global view of network state, and has a centralized network control functions such as topology and state management. The SDN controller 120 calculates routing paths and creates forwarding rules, and transfers these rules to the SDN switches 110a, 110b, and 110c.

The address resolution system in accordance with an exemplary embodiment of the present invention minimizes the number of broadcasted packets by matching an IP address with a physical layer address (that is, a MAC address) through interworking with the SDN controller 120.

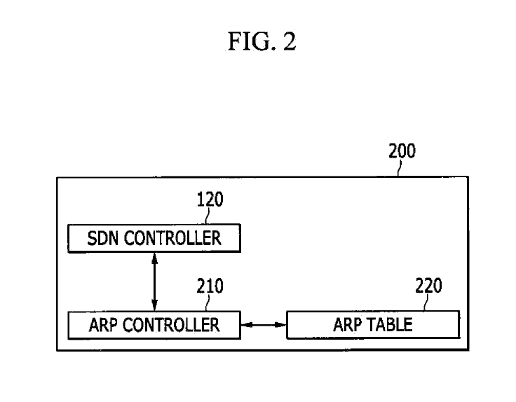

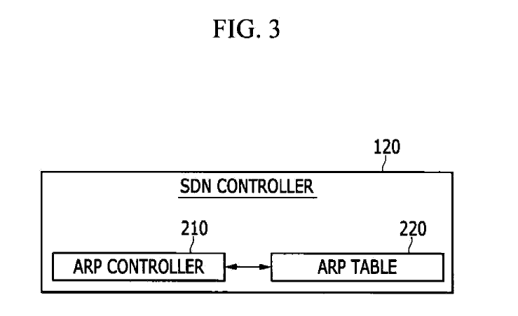

FIGS. 2 and 3 are diagrams showing an example of an address resolution system in accordance with exemplary embodiments of the present invention.

As described in FIG. 2, the address resolution system 200 includes the SDN controller 120 (that is, SDN controller in the case of FIG. 3), an address resolution protocol (ARP) controller 210, and an ARP table 220.

The ARP controller 210 checks a MAC address corresponding to an IP address, and stores the MAC address in the ARP table 220. The ARP controller 210 sets the age field of each entry in the ARP table 220.

As shown in FIG. 2, the ARP controller 210 can be implemented independently from the SDN controller 120. In contrast, as shown in FIG. 3, the ARP controller 210 and the ARP table 220 can be implemented as a module of the SDN controller 120.

If the ARP controller 210 is implemented independently as FIG. 2, the ARP controller 210 and the SDN controller 120 may communicate as a server-client structure. In this case, the ARP controller 210 and the SDN controller can communicate with each other through a predetermined protocol (e.g., an API).

The operation of the address resolution system in accordance with an exemplary embodiment of the present invention is described in detail below.

First, it is assumed that the host 10a of FIG. 1 tries to send packets to the host 10b of FIG. 1 for describing the operation of the address resolution system in accordance with an exemplary embodiment of the present invention.

The host 10a must know the IP address and MAC address of the host 10b to transmit packets. In this example, it is assumed that the host 10a has the IP address of the host 10b.

In order to know the MAC address of the host 10b, the host 10a broadcasts an ARP request packet.

If this network is an IP network and the switches 11a, 110b, and 110c are legacy switches which do not support SDN, the host 10a broadcasts the ARP request packet having the destination IP address of the host 10b. After receiving this ARP request packet, the host 10b responses with the ARP reply packet. This ARP reply packet is not broadcasted to the network because the middle switches know the MAC address of the sender host 10a already. On the other hand, the other host 10c which receives the same ARP request packet ignores this packets because the destination IP address is not that of the host 10c. After receiving the ARP reply packet, the host 10a starts transmitting packets with the IP address and MAC address of the host 10b.

In the SDN in accordance with an exemplary embodiment of the present invention, when the host 10a broadcasts an ARP request packet, the SDN switch 110a connected with the host 10a checks the rule table, which defines how to process packets, whether there is a rule to process this ARP request packet. If the rule to process ARP request packet exists, the SDN switch 110a forwards this ARP request packet to the corresponding port according to the forwarding rule. On the other hand, if there is no proper rule, the SDN switch 110a transmits this ARP request packet to the SDN controller 120 according to the basic procedure of the SDN.

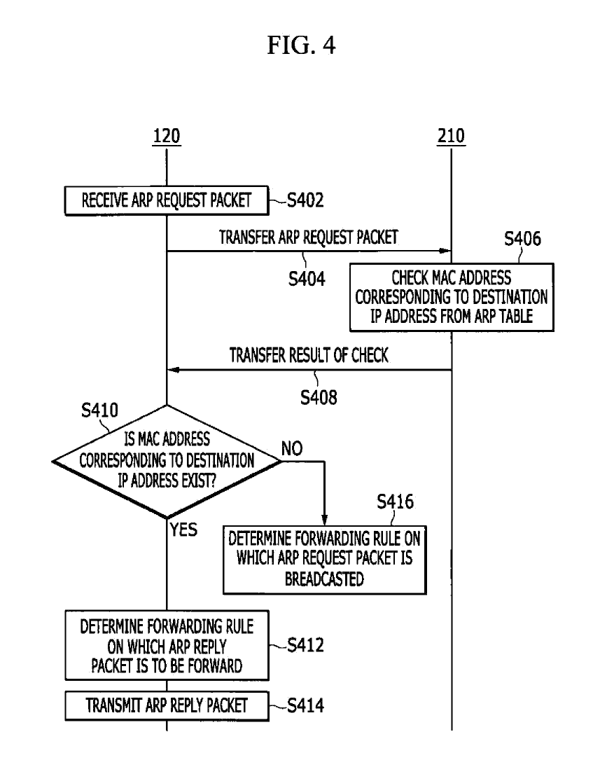

FIG. 4 is a flowchart showing a procedure of processing an ARP request packet in the address resolution system in accordance with an exemplary embodiment of the present invention.

As described in FIG. 4, if the SDN controller 120 receives the ARP request packet of the host 10a at step S402, it transmits this ARP request packet to the ARP controller 210 at step S404.

The ARP controller 210 checks whether the ARP table 220 has the MAC address corresponding to the IP address of the host 10b (that is, the destination IP address of the ARP request packet) at step S406, and transfers a result to the SDN controller 120 at step S408. When the ARP table 220 has the MAC address corresponding to the IP address of the host 10b, the result includes the MAC address corresponding to the IP address of the host 10b.

If a MAC address corresponding to the IP address of the host 10b is in the ARP table 220, it is not necessary to broadcast the ARP request packet to the entire network. In this case, SDN controller 120 transmits an ARP reply packet.

When a MAC address corresponding to the IP address of the host 10b exist in the ARP table 220 at step S410, the SDN controller 120 creates a forwarding rule so that the SDN switch 110a can forward an ARP reply packet to the host 10a at step S412, and transfers this forwarding rule to the SDN switch 110a. The SDN switch 110a configures the forwarding rule received from the SDN controller 120.

The SDN controller 120 transmits the ARP reply packet including the MAC address of the host 10b to the SDN switch 110a at step S414. When the ARP reply packet is received from the SDN controller 120, the SDN switch 110a sends the ARP reply packet to the host 10a according to the configured forwarding rule.

However, when a MAC address corresponding to the IP address of the host 10b does not exist in the ARP table 220, the SDN controller 120 cannot transmit the ARP reply packet. In this case, the ARP request packet is broadcasted as in the operation of an ARP protocol. When the MAC address corresponding to the IP address of the host 10b does not exist in the ARP table 220 at step S410, the SDN controller 120 creates a forwarding rule on which the ARP request packet of the host 10a is broadcasted at step S416, and transfers the this forwarding rule to all the SDN switches 110a, 110b, and 110c. The SDN switches 110a, 110b, and 110c configure the forwarding rule received from the SDN controller 120, and broadcast the ARP request packet of the host 10a according to the configured forwarding rule.

When the host 10b which has the IP address of the ARP request packet receives the ARP request packet, it sends the ARP reply packet with the MAC address of the host 10b.

The SDN switch 110b transfers this ARP reply packet to the SDN controller 120 because the SDN switch 110b does not know how to process this ARP reply packet.

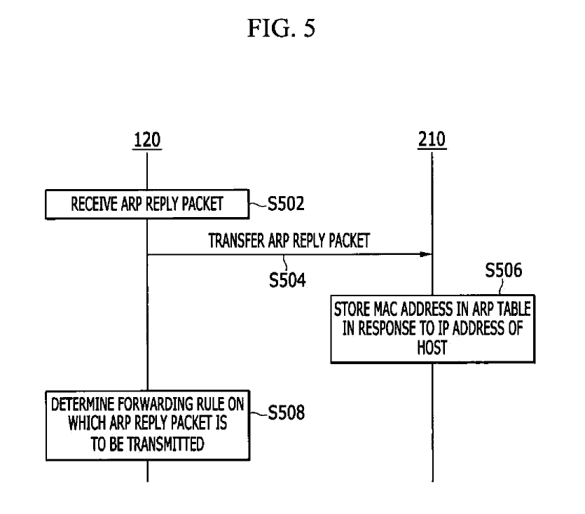

FIG. 5 is a diagram showing a method of processing an ARP reply packet in the address resolution system in accordance with an exemplary embodiment of the present invention.

As described in FIG. 5, the SDN controller 120 transfers the ARP reply packet to the ARP controller 210 at step S504 when it receives an ARP reply packet at step S502.

The ARP controller 210 updates the ARP table 220 by saving the MAC address of the host 10b corresponding to the IP address of the host 10b of the ARP reply packet at step S506.

Next, the SDN controller 120 creates a forwarding rule on which the ARP reply packet is transmitted to the host 10a at step S508, and transfers this forwarding rule to the corresponding SDN switches 110a and 110b.

Finally, the SDN switches 110a and 110b configure the forwarding rule received from the SDN controller 120 and send the ARP reply packet to the host 10a according to the configured forwarding rules.

If the host 10a receives the ARP reply packet, it checks the IP address and MAC address of the host 10b from the ARP reply packet, and starts packet transmission using the IP address and MAC address of the host 10b.

A gratuitous ARP (GARP) is used to update mapping information of other hosts in a network when host information (for example, the host 10a) is changed. The GARP protocol is used to check whether the same IP address is being already used in the network when the host 10a enters an on-line (i.e., booting) state, the IP software of the host 10a is initialized, an IP address is changed, or a network card is replaced, and to inform changed information.

The host 10a broadcasts the GARP request packet into its subnet. In this packet, the source MAC and IP addresses are the addresses of the host 10a respectively.

The hosts that have received this GARP request packet, for example, the host 10b and 10c update their own tables with the address information of GARP request packet.

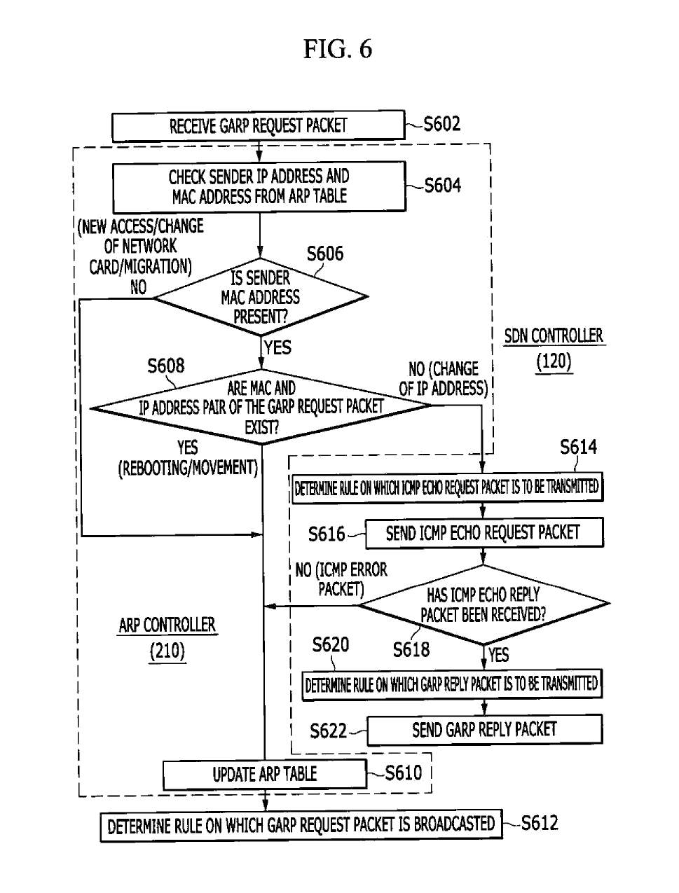

FIG. 6 is a flowchart illustrating a method of processing a GARP request packet in the address resolution system in accordance with an exemplary embodiment of the present invention.

The procedure of FIG. 6 can be applied, to the case of the host rebooting, a case where the host 10a first accesses a network, and a case where the IP address setting of the host 10a is changed.

As described in FIG. 6, if the information of the host 10a is changed, it broadcasts the GARP request packet in which the source MAC address field is the MAC address of the host 10a, and the source/destination IP address fields are the addresses of the host 10a.

When the SDN switch 110a receives the GARP request packet, it forwards this GARP request packet to the SDN controller 120.

Then, when the SDN controller 120 receives this GARP request packet at step S602, it forwards to the ARP controller 210.

The ARP controller 210 first checks the source MAC address and IP address with the ARP table 220 at step S604.

If the source MAC address does not exist in the ARP table 220, this is the case where the host 10a first accesses to a network or the case where a network card has been changed. Therefore, if the source MAC address does not exist in the ARP table 220 at step S606, the ARP controller 210 updates the ARP table 220 with the source MAC and IP address of the ARP request packet at step S610. And the SDN controller 120 creates the forwarding rules to broadcast the GARP request packet, and transfers these forwarding rules to the SDN switch 110a, 110b, and 110c. The SDN switches 110a, 110b, and 110c configure received forwarding rules, and starts to broadcast the GARP request packet according to the configured forwarding rules.

On the other hand, if the source MAC address is in the ARP table 220, this is the case where the host 10a has been rebooted or the case where an IP setting has been changed. Therefore, if the source MAC and IP addresses are in the ARP table 220, the ARP controller 210 checks whether the MAC and IP address pair of the GARP request packet is in the ARP table 220 at step S608.

If the source MAC and IP address pair of the GARP request packet is in the ARP table 220, this is the case where the host 10a has been rebooted or the case where a virtual machine which has the same MAC and IP address first accesses to this network in a virtualization environment. In this case, it is not essential to update ARP table 220, the ARP controller 210 updates the age field of the ARP table 220 at step S610. To avoid a modification of the GARP, the SDN controller 120 can create the forwarding rule to broadcast the GARP request at step S612, and transfer this rule to all SDN switches 110a, 110b, and 110c. The SDN switches 110a, 110b, and 110c configure the received forwarding rule from the SDN controller 120, and start to broadcast the GARP request packet of the host 10a.

On the contrary to upper cases, if the source MAC address in the ARP table 220 but the IP address differs, this is the case where the IP address of the host 10a has changed.

In the legacy IP network, if an IP address of the host 10a is changed, the host 10a broadcasts GARP request packet, and all the hosts 10b and 10c that have received the GARP request packet update their tables. This procedure will be completed if the changed IP address of the host 10a is not used. But if any other host already use this IP address, this host sends GARP reply packet. Therefore, if there is a GARP reply packet corresponding to the GARP request packet, this means that there is a host which already uses the same IP address. In this case, the host 10a broadcasts the GARP request packet again in order to correct the tables of all hosts 10b and 10c.

In accordance with an exemplary embodiment of the present invention, if the source MAC address is in the ARP table 220 but the IP address differs, the ARP controller 210 first checks a collision of IP addresses.

In order to check an IP collision, the ARP controller 210 requests the SDN controller 120 to transmit an Internet control message protocol (ICMP) echo request packet having the source MAC and IP address of a GARP request packet as its destination.

The SDN controller 120 creates a forwarding rule to deliver the ICMP echo request packet having the source MAC and IP address of the GARP request packet as its destination at step S614, and transfers this forwarding rule to a corresponding SDN switches. The SDN switches received this rule configure the forwarding rule.

The SDN controller 120 transfers the ICMP echo request packet to the corresponding SDN switch at step S616, and the corresponding SDN switch transmits the ICMP echo request packet according to the forwarding rule.

When the SDN controller 120 receives an ICMP echo reply packet for the ICMP echo request packet at step S618, it transfers the ICMP echo reply packet to the ARP controller 210. Therefore, if the ARP controller 210 receives the ICMP echo reply packet, this means that there is a IP collision. Accordingly, by receiving the ICMP echo reply packet, the ARP controller 210 can determine that there is an IP collision and informs this to the SDN controller 120. The SDN controller 120 creates a forwarding rule to send the GARP reply packet at step S620, and transfers this forwarding rule to the corresponding SDN switch. The SDN switch configures the forwarding rule received from the SDN controller 120.

The SDN controller 120 sends the GARP reply packet to the SDN switch at step S622, and the SDN switch sends the GARP reply packet according to the configured forwarding rule.

On the other hand, if the SDN controller 120 receives an ICMP error packet corresponding to the ICMP echo request packet, this indicates that there is no IP collision. Accordingly, if the SDN controller 120 receives an ICMP error packet corresponding to the ICMP echo request packet at step S618, the ARP controller 210 updates the ARP table 220 with the information of the GARP request packet at step S610, and the SDN controller 120 creates a forwarding rule to broadcast the GARP request packet at step S612. And all SDN switches 110a, 110b, and 110c broadcast the GARP request packet to the entire network according to the determined forwarding rule.

The aforementioned system and method for resolving an address in accordance with exemplary embodiments of the present invention can also be applied to mobile service in the SDN environment or virtual machine migration of a virtualization environment in which the host 10b changes a connection from the SDN switch 110b to another SDN switch 110c.

Although an implementation of the SDN controller 120 and the ARP controller 210 can influence partially to the control messages or an operational procedure, the migration and the mobility of the host 10b can be distinguished only by the change of the MAC and IP address from a viewpoint of the ARP controller 210.

Consider the mobile service of the host. If the host 10b moves and is connected to the other switch 110c, the MAC and IP addresses do not changed in this case.

When the host 10b moves to the SDN switch 110c, it transmits a GARP request packet including changed switch port information. In this case, the ARP controller 210 updates ARP table 220 and the GARP request packet is broadcasted according to the procedure of FIG. 6 because this case is that the MAC and IP address pair is in the ARP table 220.

A typical host migration in the virtualization environment is that a virtual machine moves to the other virtual machine. In this case, the MAC address of the host may be changed. In this case, the ARP controller 210 updates ARP table 220 and the GARP request packet is broadcasted according to the procedure of FIG. 6 because this case is that the host 10b is first connected to the network or the network card is changed.

In accordance with an exemplary embodiment of the present invention, the number of broadcasted ARP request packets can be minimized.

Furthermore, the address resolution system in accordance with an exemplary embodiment of the present invention not only does not require any change of an existing network protocol but also has a simple structure. Furthermore, it is not necessary of host settings or additional setting such as the use of an agreed IP address by the administrator.

The exemplary embodiments of the present invention are not implemented by only the aforementioned apparatus and/or method, but may be implemented by a program for realizing a function corresponding to the construction according to an exemplary embodiment of the present invention or a recording medium on which the program is recorded. The implementations will be evident to a person having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An address resolution system in a centralized control network comprising a plurality of software defined network (SDN) switches, the address resolution system comprising:
an address resolution protocol (ARP) table for storing pairs of a MAC address and IP address;
an ARP controller for checking whether the ARP table has the MAC address corresponding to the destination IP address of an ARP request packet sent from a source host through a first SDN switch; and
an SDN controller for commanding the first SDN switch to send an ARP reply packet including the corresponding MAC address to the source host if the corresponding MAC address is in the ARP table.

2. The address resolution system of claim 1, wherein if there is no corresponding MAC address in the ARP table, the SDN controller commands all SDN switches to broadcast the ARP request packet.

3. The address resolution system of claim 2, wherein when the SDN controller receives the ARP reply packet from the destination host that uses the destination IP address of the ARP request packet, the SDN controller calculates a forwarding path and makes forwarding rules to deliver the ARP reply packet, and commands all SDN switches among the forwarding path to forward the ARP reply packet to the source host.

4. The address resolution system of claim 3, wherein the ARP controller updates the ARP table using the destination IP address and MAC address pair.

5. The address resolution system of claim 1, wherein if the SDN controller receives a gratuitous ARP (GARP) reply packet from a second SDN switch of the destination host, the SDN controller determines whether or not to broadcast the GARP reply packet according to the existence of the IP and MAC address pair in the ARP table.

6. The address resolution system of claim 5, wherein:
the SDN controller checks an IP collision when the source MAC address is in the ARP table and the source IP address does not exist in the ARP table, and
if there is no collision of IP addresses, the SDN controller creates rules so that the GARP reply packet is forwarded to hosts that have changed MAC information instead of broadcasting a GARP request packet.

7. The address resolution system of claim 6, wherein:
the SDN controller sends an Internet control message protocol (ICMP) echo request packet with the source MAC and IP address according to the decision of the ARP controller; and
the ARP controller determines an IP collision when the ARP controller receives an ICMP echo reply packet corresponding to the ICMP echo request packet.

8. The address resolution system of claim 7, wherein the SDN controller creates rules to the SDN switches so that the GARP request packet is broadcasted to the network if the SDN controller receives an error packet corresponding to the ICMP echo request packet.

9. The address resolution system of claim 5, wherein the SDN controller creates rules to the SDN switches so that the GARP request packet is broadcasted to the network if the source IP and MAC address pair exists in the ARP table.

10. The address resolution system of claim 9, wherein the ARP controller sets an age field for an entry if the source IP and MAC address pair exists in the ARP table.

11. The address resolution system of claim 5, wherein the ARP controller stores the source MAC address corresponding to the source IP address to the ARP table if the source MAC address does not exist in the ARP table.

12. A method of resolving, by an address resolution system, a MAC address corresponding to an IP address in a centralized control network comprising a plurality of software defined network (SDN) switches, the method comprising:
receiving, by an SDN controller, an ARP request packet from a source host;
checking, by an address resolution protocol (ARP) controller, a MAC address corresponding to a destination IP address of the ARP request packet exists in an ARP table; and
determining, by the SDN controller, whether broadcast the ARP request packet according to the existence of the MAC address corresponding to the destination IP address.

13. The method of claim 12, wherein the determining comprises:
broadcasting the ARP request packet if the MAC address corresponding to the destination IP address of the ARP request packet does not exist in the ARP table; and
forwarding tan ARP reply packet with the MAC address to the source host if the MAC address corresponding to the destination IP address of the ARP request packet exists in the ARP table.

14. The method of claim 13, further comprising:
receiving, by the SDN controller, an ARP reply packet with the MAC address of a host that uses same IP address among hosts that have received the broadcasted ARP request packet; and
forwarding, by the SDN controller, the ARP reply packet to the source host.

15. The method of claim 14, wherein the receiving of the ARP reply packet comprises updating, by the ARP controller, the ARP table using the destination IP and MAC address pair.

16. The method of claim 12, further comprising:
receiving, by the SDN controller, a gratuitous ARP (GARP) request packet from a host that have changed the MAC information;
determining, by the ARP controller, whether or not the ARP table has a source IP address and a source MAC address of the GARP request packet;
checking, by the ARP controller, the existence of the source IP and MAC address pair of the GARP request packet in the ARP table; and
broadcasting, by the SDN controller, the GARP request packet according to the existence of the source IP and MAC address pair.

17. The method of claim 16, wherein the broadcasting of the GARP request packet comprises broadcasting the GARP request packet to the network if the source MAC address does not exist in the ARP table.

18. The method of claim 16, wherein the broadcasting of the GARP request packet comprises:
checking an IP collision if the ARP table does not have the source 1P address but has the source MAC address; and
forwarding the GARP reply packet to hosts that have changed information if there is an IP collision.

19. The method of claim 16, wherein broadcasting of the GARP request packet comprises broadcasting the GARP request packet to the network if the source MAC address and IP address pair is in the ARP table.
